(19) United States
(12) Patent Application Publication
(10) Pub. No.: US 2008/0007942 A1
(43) Pub. Date: Jan. 10, 2008

(54) MOUNTABLE LIGHT WITH INTEGRATED ACTIVATION SENSOR

(76) Inventors: Patrick H. Ruggles, Solon, OH (US); Roger L. Shankland, Norton, OH (US)

Correspondence Address: HAHN LOESER & PARKS, LLP, One GOJO Plaza, Suite 300, AKRON, OH, 44311-1076, US

(21) Appl. No.: 11/686,657

(22) Filed: Mar. 15, 2007

Related U.S. Application Data
(60) Provisional application No. 60/784,073, filed on Mar. 17, 2006.

(51) Int. Cl. F21S 8/04; F21S 8/00

(52) U.S. Cl. 362/147; 362/145

(57) ABSTRACT

A light fixture includes a frame for mounting the fixture to a wall or other structural element of a house or building. The fixture includes a controller and a sensor that detects heat. When the sensor detects a change in temperature or other condition, it signals the controller to turn the light on and/or off. The sensor may be a passive infrared sensor (PIR sensor) mounted directly to the fixture.

This utility patent application claims priority to U.S. provisional patent application Ser. 60/784,073 filed on Mar. 17, 2006, which is incorporated herein by reference in its entirety.

### TECHNICAL FIELD

The present invention pertains to lighting fixtures, and more specifically, to mountable lighting fixtures having an integrated sensor electrically connected to automatically activate the lighting fixture.

### BACKGROUND OF THE INVENTION

Lighting receptacles and fixtures are well known in the art to electrically connect to lighting switches, which may be wired into an electrical circuit for use in selectively turning the light on and off. Typically, electrical conductors are routed from the lighting fixture through the wall or ceiling of a room in which the fixture is mounted. The conductors are connected to the switch, which is frequently located proximate to the entrance way of the room for convenient access by a person entering the room. In many circumstances the person entering a room may be bringing in various items, possibly large and/or heavy. In this situation, the person's hands may be occupied in carrying the items and may not be readily available to turn the light switch on. In would be advantageous to have a light that automatically turned on when a person enters a room.

Another aspect of lighting fixtures pertains to the installation of the fixture into a pre-existing room or area. In certain circumstances, electrical power may be amply available at the mounting site of the fixture. However, it may be difficult to route additional conductors through an existing wall for connection to a switch to be located distally to the entrance way of the room. In this instance, it would also be advantageous to have a light fixture that includes an integrated activation switch.

What is needed is an activation sensor that is integrated into a lighting fixture where a switch automatically turns the light on and off responsive to a person entering the room or area where the light is mounted. The present invention obviates the aforementioned problems.

### BRIEF SUMMARY

In one embodiment of the present invention a light fixture for use in the interior of a building includes a light fixture base adapted for mounting to an indoor structural member, at least one electrical receptacle connected to the light fixture base and a sensor electrically communicated to automatically activate the at least a first electrical receptacle when the sensor detects a passerby.

In one aspect of the embodiments of the present invention the light fixture base is adapted for mounting to an associated junction box where the junction is located or mounted to the studs in the wall of a building or other structure.

In another aspect of the embodiments of the present invention the sensor is integrated into the light fixture base.

In yet another aspect of the embodiments of the present invention the light fixture base includes a base plate and a stem extending outward from the base plate where the sensor is pivotally and/or rotatably integrated into the stem.

In still another aspect of the embodiments of the present invention the sensor is moveably connected to the light fixture base for adjusting the sensing range of the sensor.

In another embodiment of the present invention the light fixture includes a sensor controller electrically connected between power supplied to the lighting fixture and the sensor where the sensor controller automatically deactivates the at least a first electrical receptacle after a predetermined amount of time. The sensor controller may be programmable for selectively adjusting the amount of time for automatically deactivating the at least a first electrical receptacle.

### BRIEF DESCRIPTION OF THE DRAWINGS

FIG. 1 is a perspective view of the mountable lighting fixture, in accordance with various aspects of the present invention.

FIG. 2 is a partial cutaway view of the lighting fixture mounted to a wall, in accordance with various aspects of the present invention.

FIG. 3 is a schematic representation of the electrical components and connection of the lighting fixture, in accordance with various aspects of the present invention.

### DETAILED DESCRIPTION OF THE INVENTION

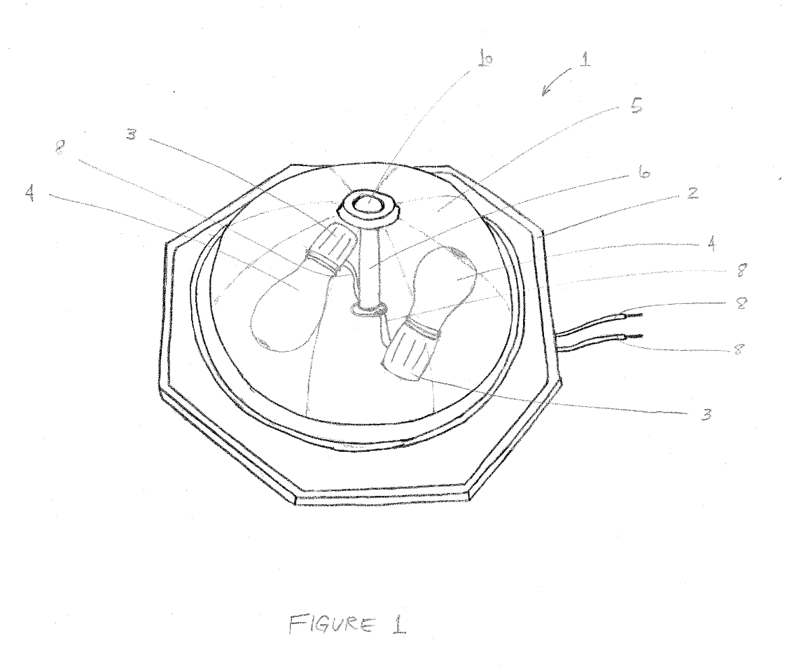

Referring now to the drawings wherein the showings are for purposes of illustrating embodiments of the invention only and not for purposes of limiting the same, FIG. 1 shows a lighting fixture depicted generally at 1. The lighting fixture 1 may include a base 2 that can be mounted to an associated wall, ceiling or other structural member for use in connecting to a power source in order to provide illumination. The base 2 may comprise a framework or lighting fixture frame 2 onto which the components of the lighting fixture 1 may be mounted. One component of the lighting fixture 1 may include a globe 5 or light diffusing member 5′. The globe 5 may be removably fastened to the base 2 and may function to diffuse light emanating from the fixture 1. The globe 5 may also have decorative properties. The lighting fixture 1 may additionally include one or more receptacles 3 that receive light bulbs 4. The light bulbs 4 may be incandescent bulbs. However, other types of illuminating bulbs may be utilized including but not limited to fluorescent bulbs. Accordingly, the light fixture may incorporate transformers or ballasts, not shown, as needed. The receptacles 4 may be fixedly mounted to a stem 6, which may be a central post 6, such that the bulbs 4 are positioned to maximize the illuminating effect. Alternatively, the receptacles 4 may be pivotally mounted to the central post 6 and selectively positioned to create any desired illuminating effect. It is noted here that any manner of mounting or affixing the receptacles 3 to the light fixture l may be chosen as is appropriate for use with the subject invention. Electrical conductors 8 may extend from the receptacles 3 through the fixture for connecting to a power source as will be discussed in a subsequent paragraph. The lighting fixture 1 may further incorporate a sensor 10 connected into the electrical circuit for use in detecting the presence of a person entering into a predefined area of the sensor 10 and subsequently for automatically activating the lighting fixture 1.

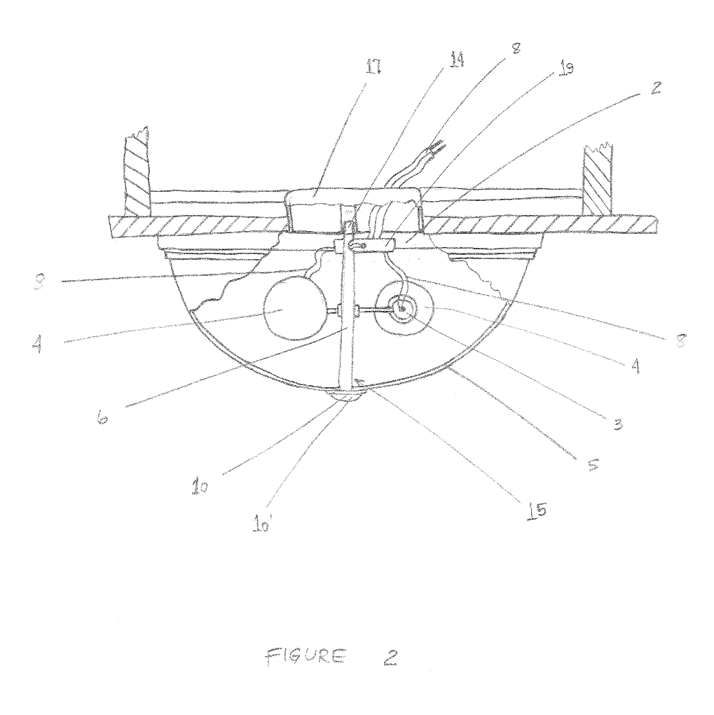

With reference now to FIGS. 1 and 2, as mentioned above, the lighting fixture 1 may be mountable to a wall, ceiling or other structure. In one embodiment, the lighting fixture 1 may be mountable to a standard junction box 17, which may include a metal bracket or strap, not shown. The junction box 17 itself may be embedded into the wall or ceiling in a manner well known in the art. The central post 6 of the lighting fixture 1 may have a threaded portion 14 fashioned at one end of the central post 6 for use in fastening the lighting fixture 1 to the junction box by screwing into the bracket or strap. Alternatively, screws or fasteners may be utilized to affix the base 2 to the bracket of the junction box 17. However, any means of mounting the lighting fixture 1 to the junction box 17 or another structural element may be chosen as is consistent for use with the present invention.

With reference to FIGS. 1 through 3, as described earlier the lighting fixture may include a sensor 10, which may be integrated directly into the lighting fixture 1. In one embodiment, the sensor 10 may be affixed at end 15 to the central post 6. Electrical conductors may extend from the sensor 10 internally through the central post 6 to a sensor controller 19 to be described in detail below. The sensor 10 may be a passive infrared (PIR) sensor 10′, which detects heat radiating from an object such as a hand, arm or torso. One type of PIR sensor may utilize a pyroelectric transducer. As PIR sensors 10′ operate strictly within the line of sight, integrating the sensor 10′ to face into the room may maximize the detection pattern of the sensor 10′. However, it is noted that the PIR sensor 10′ may be placed or integrated into any portion of the lighting fixture 1 or positioned in any direction as chosen with sound engineering judgment. It is anticipated in an alternate embodiment, that the sensor 10 may include other types of transducers. One alternate type of device may include ultrasonic transducers. Another type of device may include photoelectric transducers. Yet another type of activating device may include the combination of both automatic sensor activation and manual activation of the lighting fixture 1. Still, any type or quantity of sensors may be used as is appropriate for activating the lighting fixture 1. By activation of the lighting fixture it is meant that the illuminating power is selectively connected or disconnected with respect to the lighting fixture.

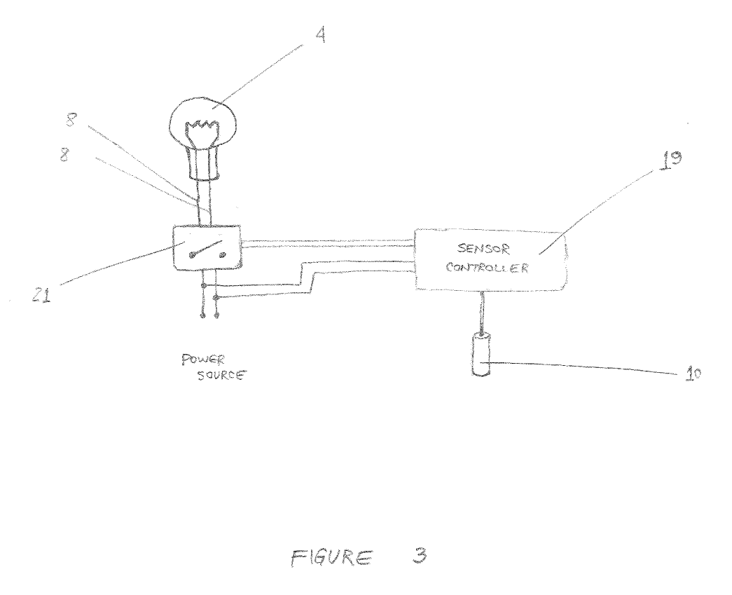

With continued reference to FIG. 3, the transducer of the PIR sensor 10′ may be energized from an external source. As discussed above, power from an associated power source, which may be standard electrical power as found in a house or office, may be connected to the lighting fixture 1 for illuminating the bulbs 4. Similarly, power from the same source may be connected to the sensor controller 19. The sensor controller 19 may draw operating power from the external source. Typically, transducers provide an electrical output responsive to some input stimulus. The transducer may detect a change in a specific condition. In the current embodiment, the PIR sensor 10′ may specifically detect heat radiating from a person entering a room. The PIR sensor 10′ may sense the heat and generate a voltage output in response thereto. The signal generated by the sensor 10′ is communicated to the sensor controller 19, which may process the sensor 10′ signal and automatically activate the lighting fixture 1. In one embodiment, a switch 21, which may be a relay, may be incorporated into the circuit between the sensor controller 19 and the bulb 4. In a manner consistent with the operation of relays 21, an electrical signal from the sensor controller 19 may engage the relay 21 to connect power from the associated external source to the light bulbs 4. In like manner, the absence of a signal from the sensor controller 19 may disengage the relay 21 wherein the light bulbs 4 would be automatically turned off. It is to be construed that while the present embodiment discusses the use of a relay, other types of switches may be used to selectively communicate power to the light bulbs. Examples of these types of devices may include but is not limited to: power transistors, solid state circuitry, digital logic circuits, bimetallic devices, coils and solenoids. In this manner, the lighting fixture 1 may sense the presence of a person entering a room or predefined region and may automatically activate the lighting fixture 1 to illuminate the bulbs 4 contained within.

With reference to all of the FIGURES, operation of the present invention will now be discussed. The lighting fixture 1 may be positioned proximate to a rigid structure or wall wherein electrical conductors are available to connect power to the lighting fixture 1. The lighting fixture 1 may be positioned such that the integrated sensor 10′ is pointed in the desired direction of detecting a person entering the area. The lighting fixture may then be connected to the power source and securely mounted to the rigid structure or wall. Once installed, the sensor 10 of the lighting fixture l may scan a predefined area for changes in the passive heat radiation. If a change is detected, the sensor 10′ will output a signal that is received by the sensor controller 19. The sensor controller 19 may then automatically activate a switch that connects power to the receptacles 3 and the light bulbs 4. When the person exits the detection area of the sensor 10′, the sensor 10′ ceases to output an electrical signal. Accordingly, the sensor controller 19 may be programmed to deactivate the switch 21 immediately or after a predetermined amount of time. In this manner, the lighting fixture 1 would automatically deactivate when a specific time period of inactivity of the sensor 10′ has expired. This prevents the lighting fixture 1 from turning off prematurely while the person is momentarily still. It is noted that any time period may be programmed into the sensor controller 19 as is appropriate for use with the present invention.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

I/we claim:

1. A light fixture for use in the interior of a building, comprising:
a light fixture base adapted for mounting to an indoor structural member;
at least a first electrical receptacle operatively attached to the light fixture base; and,
a sensor electrically communicated to automatically activate the at least a first electrical receptacle when the sensor detects a passerby.

2. The light fixture as defined in claim 1, wherein the light fixture base is adapted for mounting to an associated junction box located in the wall of an associated building.

3. The light fixture as defined in claim 1, wherein the sensor is integrated into the light fixture base.

4. The light fixture as defined in claim 3, wherein the light fixture base includes a base plate and a stem extending outward from the base plate; and,
wherein the sensor is integrated into the stem.

5. The light fixture as defined in claim 3, wherein the sensor is moveably connected with respect to the light fixture base for adjusting the sensing range of the sensor.

6. The light fixture as defined in claim 1, wherein the sensor is a passive infrared sensor.

7. The light fixture as defined in claim 1, wherein the sensor is an ultrasonic sensor.

8. The light fixture as defined in claim 1, wherein the at least a first electrical receptacle is adapted to receive one or more associated light bulbs, wherein the associated light bulbs are fluorescent light bulbs; and further comprising:
a ballast electrical connected between an associated power source and the associated fluorescent light bulbs.

9. The light fixture as defined in claim 1, wherein the at least a first electrical receptacle is adapted to receive one or more associated incandescent light bulbs.

10. The light fixture as defined in claim 1, further comprising:
a sensor controller electrically connected between an associated power supply and the sensor, wherein the sensor controller automatically deactivates the at least a first electrical receptacle after a predetermined amount of time.

11. The light fixture as defined in claim 10, wherein the sensor controller is programmable for selectively adjusting the amount of time for automatically deactivating the at least a first electrical receptacle.

12. A ceiling mounted light fixture, comprising:
a light fixture base;
at least a first light socket mounted to the light fixture base;
a globe overlying the at least a first light socket; and,
a motion sensor electrically communicated to automatically activate the at least a first light socket, wherein the motion sensor is mounted exterior to the globe for sensing motion of a passerby.

13. The light fixture as defined in claim 12, wherein the sensor controller automatically deactivates the at least a first light socket after a predetermined amount of time.

14. The light fixture as defined in claim 13, wherein the sensor controller is programmable for selectively adjusting the amount of time for automatically deactivating the at least a first light socket.

15. The light fixture as defined in claim 13, wherein the sensor controller is selectively adjustable between automatically or manually activating the ceiling mounted light fixture.

16. The light fixture as defined in claim 13, wherein the motion sensor incorporates a pyroelectric transducer.

17. The light fixture as defined in claim 12, further comprising:
a central post extending outward from the light fixture base, wherein the motion sensor is integrated into the central post.

18. The light fixture as defined in claim 12, wherein the motion sensor is rotatably connected to the light fixture base for adjusting the sensing range of the motion sensor.

19. The light fixture as defined in claim 12, wherein the at least a first light socket is adapted to receive one or more associated light bulbs, wherein the associated light bulbs are fluorescent light bulbs; and further comprising:
a ballast electrical connected to the associated fluorescent light bulbs.

20. The light fixture as defined in claim 12, wherein the at least a first light socket is adapted to receive one or more associated incandescent bulbs.
